(19) United States
(12) Patent Application Publication
(10) Pub. No.: US 2024/0083802 A1
(43) Pub. Date: Mar. 14, 2024

(54) INTERLEAVING POWDER

(71) Applicant: CHEMETALL GMBH, Frankfurt (DE)

(72) Inventors: Joachim ESSER, Mönchengladbach (DE); Kevin SKRISCHOWSKI, Mönchengladbach (DE); Hendrik FRIEDRICH, Mönchengladbach (DE)

(21) Appl. No.: 18/263,476

(22) PCT Filed: Feb. 25, 2022
(86) PCT No.: PCT/EP2022/054814

§ 371 Date: Jul. 28, 2023

(30) Foreign Application Priority Data
Feb. 26, 2021 (EP) 21159473.4

(51) Int. Cl. C03B 40/033; B65G 49/06

(52) U.S. Cl. CPC C03B 40/033; B65G 49/069

(57) ABSTRACT

Described herein is a method for spacing glass sheets from one another during stacking of the glass sheets, where the method includes:
applying an interleaving powder material between adjacent glass sheets, where a composition including a powdered support material is employed, which is selected from a natural composite material based on cellulose, hemicellulose and/or lignin as the interleaving powder material between the adjacent glass sheets.

### FIELD OF INVENTION

The present invention relates to a method for spacing glass sheets from one another during stacking of the glass sheets, to a combination of stacked glass sheets and interleaving powder located between stacked glass sheets, to a method for producing the combination of stacked glass sheets and interleaving material mentioned above by spacing glass sheets from one another during stacking of the glass sheets and to the use of the composition according to the invention as a sustainable interleaving powder for glass.

### STATE OF THE ART

Flat glass is stored and transported in large sheets (e.g., 6×3 m) on a rack. Due to the chemical reactivity of the glass surfaces, the glass surfaces can react which each other, which makes them non separable after a certain time. Therefore, a separating agent must be placed between the individual glass sheets. Well known materials are paper or plastic beads for this purpose. During transport and storage water can condensed between the glass sheets and causing a hydrolysis of glass known as “glass corrosion”. This can be prevented by adding chemicals to the used paper or plastic beads.

US 2005/0260342 A1 discloses a glass sheet interleaving material, which includes a mixture of polymer inclusive beads or particles of material such as polymethylmethacrylate, and a stearate such as an acid stearate or the metal salt of an acid stearate. The interleaving material mixture may be applied to the glass sheets in any suitable manner.

EP 0192810 A2 describes a composition of matter useful as an interleaving material for separating glass sheets and providing stain resistance to the glass surfaces, which composition comprises a porous powdered support material impregnated with a strong organic acid. The porous powdered support material is wood flour and the organic acid is an organotin halide.

EP 2940208 A1 discloses a wood pulp for glass plate-interleaving paper wherein an amount of silicone contained in the wood pulp is 0.5 ppm or less with respect to an absolute dry mass of the wood pulp. The silicone described therein is a silicone oil or dimethylpolysiloxane.

In modern flat glass industry, a plastic powder (interleaving powder) is placed between glass sheets to ensure an easy separation of the glass after storage and transport.

The plastic powders consist preferably on PMMA bead polymers with a medium grain size of 50 to 170 μm.

For special purposes also different plastic materials are used (e.g., UHMW polyethylene or crosslinked polystyrene). These plastic materials consist on a fine powder with a medium grain size of 50 to 200 μm.

Chemicals are added to these plastic powders to prevent glass corrosion. Mostly used materials are acids in powder form (e.g., adipic acid and boric acid)

The used plastic materials must withstand the mechanical impact during transport (pressure and abrasion resistance) to avoid glass defects and breakage. The thermal and weathering resistance must be high to ensure an easy removal of the beads at the end customer application. All interleaving powder is removed from the glass in the end application. The products will go to filtering systems or to sewage water.

Chemetall GmbH is selling above mentioned products for more over 30 years (AC Separol products) globally to all big flat glass groups. The AC Separol products are either pure polymeric products or acid mixed products to prevent glass corrosion.

Chemetall GmbH is offering different kind of polymers (PMMA, polyethylene, polystyrene and polyamides) and has a high knowledge of the impact of the polymer powders to glass surfaces and the prevention of glass corrosion. Therefore, appropriate lab tests have been developed.

Almost all known interleaving powders, which are currently used in flat glass industry consist of plastic materials. The plastic materials are removed completely after application and may get to environmental compartments, thus creating environmental issues.

Fine plastic materials are considered as hazardous for marine compartments (micro plastic beads). Global restrictions to ban those materials have been started.

In the European Union a discussion about a restriction of those materials has started in January 2018 (Restricting the use of intentionally added microplastic particles to consumer or professional use products of any kind.)

In a new draft of this guideline in June 2020 the ban of the use of micro plastic for transportation of glass sheets has been noted (also for industrial application).

It might be reasonably assumed, that in the year 2022 the now used plastic interleaving powders cannot be used anymore for the transportation of glass sheets. Therefore, there is a need for the development of “sustainable interleaving powders”, which are not restricted by the European Union micro plastic guideline and further there is a need for the provision of suitable methods for spacing glass sheets from one another during stacking of the glass sheets.

Due to the grounds of sustainability and economical aspects there is an effort to seek for alternative solutions for the conventional interleaving powders and for related methods for spacing glass sheets from one another during stacking of the glass sheets. Therefore, the task of the invention is the provision of a method for spacing glass sheets from one another during stacking of the glass sheets, which is environment-friendly and easy to apply and is not treated with, e.g., organotin compounds such as organotin halides.

### SUMMARY AND DETAILED DESCRIPTION

This task is solved with the provision of a method for spacing glass sheets from one another during stacking of the glass sheets, characterized in that the method comprises
applying an interleaving powder material between adjacent glass sheets whereby
a composition comprising a powdered support material is employed, which is selected from a natural composite material based on cellulose, hemicellulose and/or lignin as the interleaving powder material between the adjacent glass sheets.

Chemetall has been working for sustainable interleaving powders since several years. Tested materials were natural polymers and chemically modified polymers. According to the new draft of the European Union micro plastic guideline only natural polymers are considered now.

The natural composite material is selected from the group consisting of fruit kernel flour, cellulose-based powder, lignin-based powder or a mixture thereof.

Since as an interleaving powder material a composition is used which comprises
a powdered support material which is selected from natural composite material, and
the natural composite material is selected from the group consisting of fruit kernel flour, cellulose-based powder, lignin-based powder or a mixture thereof;
   it is equivalent that the powdered support material is selected from the group consisting of fruit kernel flour, cellulose-based powder, lignin-based powder or a mixture thereof.

Thus, the method for spacing glass sheets from one another during stacking of the glass sheets can also be worded in that the method comprises
applying an interleaving powder material between adjacent glass sheets whereby
the interleaving powder material between the adjacent glass sheets is employed as a composition comprising a powdered support material, the powdered support material being selected from the group consisting of fruit kernel flour, cellulose-based powder, lignin-based powder or a mixture thereof.

Several natural materials have been tested according to the own developed “test set for interleaving powders” and are usable as interleaving powders for transportation and storage of glass sheets.

It has been turned out, that the following natural powders are usable as interleaving powders for glass industry:
fruit kernel flour, selected from the group, consisting of olive pit flour, almond shell powder, peach stone powder, pistachio shell powder, avocado stone powder, grapes kernel powder, apricot stone powder, argan shell powder, corncob flour, walnut shell flour, manioc flour, guar gum, soya flour, chickpea flour or a mixture thereof. Particularly preferred fruit kernel flour is selected from olive pit flour, walnut shell powder, almond shell powder, grape kernel powder and corncob flour, amongst which olive pit flour and walnut shell powder are even more preferred.
cellulose based powders (physically modified cellulose particles). The base material mostly origins from trees. These products are available in different purity and shapes. Preferably, the cellulose-based powder is not wood flour, but a purified cellulose material made of, e.g., wood flour. Wood flour used in the prior art is typically treated with organotin compounds such as organotin halides such as those mentioned hereinafter. Particularly preferred as a cellulose-based powder is cellulose, preferably cellulose having a purity of at least 90 wt.-%, more preferred at least 95 wt.-%, even more preferred at least 97 wt.-% and most preferred at least 99 wt.-% based on the total weight of the cellulose-based powder.
products based on lignin (e.g., Lignocel).

Also, a combination of the above-mentioned powders is suitable.

The raw materials have to be screened to a specific particle size distribution to fulfill the tests.

Further the interleaving powder material comprises at least one flow additive.

Additives can be mixed to these powders to enhance certain properties (e.g., flowability).

The amount of these additives is in the range of 0 to 5%, preferably 0.2 to 0.5%, thus such additives can be present, but are not necessarily present.

Examples of such additives can be additives based on pyrogenic silica, precipitated silica or pyrogenic metal oxides (e.g., aluminum oxide, titanium oxide).

The modified materials have been tested according to following tests:
Temperature resistance (separation and easy removal)
Behavior inside weathering tests (separation, anticorrosion properties, washability)
Flowability
Glass adhesion, behavior on powdering units

The tested materials can be mixed with acids to ensure an anticorrosion resistance and for protection of glass corrosion.

Preferably such acids could be boric acid, adipic acid or succinic acid. The mixing range of the acids is up to 80 wt.-%, such as 5 to 80%, based on the total weight of the composition and more preferably 5 to 70 wt.-% or 8 to 60 wt.-%, most preferred 10 to 50%.

The acid is selected from the group, consisting of adipic acid, succinic acid and boric acid. It also turned out, that some products (e.g., olive pit flour) provide an anticorrosion resistance without adding an acid.

Taking into account that the amount of flow additive, based on the total weight of the composition, is from 0 to 5 wt.-%, the composition preferably comprises 5 to 95 wt.-% powdered support material, and 0 to 5 wt.-% flow additive, based on the total weight of the composition. Taking further into account that the amount of the above-mentioned acids, if present, is from 5 to 80 wt.-%, the composition preferably comprises 5 to 95 wt.-% powdered support material, and 0 to 80 wt.-% of the above-mentioned acids, based on the total weight of the composition. Taking into account the above-mentioned acids and flow materials, the composition preferably comprises 5 to 95 wt.-% powdered support material, 0 to 5 wt.-% flow additive, and 0 to 80 wt.-% of the above-mentioned acids, based on the total weight of the composition.

The composition according to the invention preferably comprises
5 to 95 wt.-% powdered support material,
0.1 to 5 wt.-% flow additive, based on the total weight of the composition,
   more preferably
7 to 95 wt.-% powdered support material,
0.1 to 3 wt.-% flow additive, based on the total weight of the composition.
   and most preferably
9.5 to 95 wt.-% powdered support material,
0.2 to 0.5 wt.-% flow additive, based on the total weight of the composition.

As disclosed herein above and below, the compositions can be mixed with the above-mentioned acids, preferably adipic acid or succinic acid, in the range up to 80 wt.-%, preferably from 5 to 80 wt.-%, more preferably 5 to 70 wt.-%, even more preferred 8 to 60 wt.-% and most preferred 10 to 50 wt.-%, based on the total weight of the composition, if a further improvement of protection against glass corrosion is desired.

In the following preferred compositions are described taking into account the above ranges. A preferred composition, e.g., comprises 15 to 99.9 wt.-% powdered support material, 0.1 to 5 wt.-% flow additive, 0 to 80 wt.-% of the above-mentioned acids, all percentages being based on the total weight of the composition; or more preferred 30 to 99.9 wt.-% powdered support material, 0.1 to 3 wt.-% flow additive, 0 to 70 wt.-% of the above-mentioned acids, all percentages being based on the total weight of the composition; or even more preferred 40 to 99.9 wt.-% powdered support material, 0.15 to 1 wt.-% flow additive, 0 to 70 wt.-% of the above-mentioned acids, all percentages being based on the total weight of the composition; or most preferred 45 to 99.9 wt.-% powdered support material, 0.2 to 1 wt.-% flow additive, 0 to 60 wt.-% or 5 to 60 wt.-% or 8 to 60 wt.-% of the above-mentioned acids; all percentages being based on the total weight of the composition.

The powdered support material in the preceding paragraph is preferably selected from cellulose-based material such as cellulose, even more preferred cellulose having a purity of at least 90 wt.-%, more preferred at least 95 wt.-%, even more preferred at least 97 wt.-% and most preferred at least 99 wt.-% based on the total weight of the powdered support material; or preferably selected from fruit kernel flour selected from the group, consisting of olive pit flour, almond shell powder, peach stone powder, pistachio shell powder, avocado stone powder, grapes kernel powder, apricot stone powder, argan shell powder, corncob flour, walnut shell flour, manioc flour, guar gum, soya flour, chickpea flour or mixtures thereof, particularly preferred selected from olive pit flour, walnut shell powder, almond shell powder, grape kernel powder and corncob flour, and mixtures thereof, amongst which olive pit flour and walnut shell powder and mixtures thereof are even more preferred olive pit flour. Of course, mixtures or the afore-mentioned cellulose-based material and fruit kernel flour can be employed in the method, too. The flow additive in the preceding paragraph is preferably selected from pyrogenic silica, precipitated silica or pyrogenic metal oxides such as aluminum oxide and titanium oxide, and mixtures thereof, even more preferred selected from pyrogenic silica and pyrogenic aluminum oxide and mixtures thereof. The acids in the preceding paragraph are preferably selected from boric acid, adipic acid and/or succinic acid, even more preferred adipic acid and succinic acid and mixtures thereof, even more preferred adipic acid. Any of the amount ranges of the preceding paragraph can preferably be combined with the preferred ingredients listed in the present paragraph.

The powder support material is a natural material and thus preferably not impregnated or otherwise associated with organotin compounds, particularly organotin halides such as methyltin trichloride, dimethyltin dichloride, trimethyltin chloride and mixtures thereof.

All of the above ingredients as used in the compositions preferably add up to 100 wt.-% of the composition.

As mentioned above, the raw materials have to be screened to a specific particle size distribution to fulfill the tests.

It is preferred that the medium particle size (volume median particle size Dv(50), as determined by laser diffraction, e.g., using a Malvern Mastersizer 3000 from Malvern Panalytic) of the powdered support material and the flow additives is 50 to 250 μm, more preferably 60 to 210 μm and most preferably 80 to 150 μm.

The powdered support material and the flow additives are screened to a specific particle size of 50 to 250 μm, more preferably 60 to 210 μm and most preferably 80 to 150 μm.

And still a further aspect of the invention is the combination of stacked glass sheets and interleaving powder located between stacked glass sheets which is characterized in that the interleaving powder comprises a composition according to the invention.

Another aspect of the invention is a method for producing the combination of stacked glass sheets and interleaving material mentioned above by spacing glass sheets from one another during stacking of the glass sheets, wherein the method comprises
applying an interleaving powder between adjacent glass sheets whereby
a composition comprising a powdered support material is employed, which is selected from a natural composite material described above as the interleaving powder material between the adjacent glass sheets.

A further aspect is the use of the above-described method for spacing glass sheets from one another during stacking of the glass sheets for the storage and transport of glass, non-coated flat glass and glass coated with an anticorrosive coating (sputtered glass and lacquered glass).

Products based on kernel flours (e.g., olive pit flour and corn cob flour) are usable for the storage and transport of noncoated flat glass. Those products can also be used for glass coated with an anticorrosive coating (e.g., AC Resistain TC).

Products based on cellulose-based powders (e.g., Arbocel types, Vivapur and Vivapur spheres types) may be usable for coated glass (sputtered glass and lacquered glass). Such products mixed with acids (adipic acid) may also be usable for storage and transport for noncoated flat glass.

The invention is further described by way of example, without limiting the invention in any manner.

### EXAMPLES

Product Description

Product type 1 consists on fruit kernels, which have been milled down to needed particle size (fruit kernel flours).

Examples for such products could be kernels from olives, walnuts, corn cob, almond, grapes. Good results have been achieved by olive pits and walnut kernels.

These products consist on a natural composite material based on cellulose, hemicellulose and lignin.

Product type 2 consists on cellulose particles which have been generated from wood or vegetable fibers and have been purified.

Such products are, e.g., available from company Rettenmaier (Arbocel, Vivapur, Vivaspheres, Lignocel, Heweten types). Good results have been achieved with the Arbocel Types.

These products consist also on a natural composite material based on cellulose, hemicellulose and lignin.

Particle size ranges for these products are:

Medium particle size: 50 to 250 μm, preferable: 80 to 150 μm. Preferably the fine parts below 40 μm and the oversize above 300 μm are less than 5%. Particle size is checked by aid of a laser system, sieve analysis or by microscopy, particularly preferred by layer diffraction analysis using a Malvern Mastersizer 3000 from Malvern.

Additives can be mixed to these powders to enhance certain properties (e.g., flowability). The amount of these additives is in the range of 0 to 5%, preferably 0.2 to 0.5%. Examples of such additives can be additives based on pyrogenic silica, precipitated silica or pyrogenic metal oxides (e.g., aluminum oxide, titanium oxide).

Interleaving powder base polymers for glass storage and transport must have following properties:
Excellent pressure/temperature resistance
Good resistance against weathering
Excellent separation behavior after storage and transport
Good removal of the powder after separation either by blasting off with pressurized air or inside washing process.
Good distribution and glass adhesion after application of the product in common powdering units (e.g., spraying lines or roller lines)
Low dust behavior for safety reasons
Miscibility with inorganic or organic acids to ensure a good protection against glass corrosion.

Preferably such acids could be boric acid, adipic acid or succinic acid. The mixing range of the acids is 5 to 80%, based on the total weight of the composition and preferably 10 to 50%.

There do not exist standardized tests for evaluating these properties. The new products were tested according to own developed methods.

Pressure/Temperature Resistance

The test is conducted with glass sheets inside a special clamp system. The glass sample to be tested is powdered manually or by aid of powdering unit with an amount of 100 to 1000 mg/m². It is covered with a second glass samples. The sandwich is put inside the clamp system and a high force ranging from 500 N to 2000 N (preferably 800 N) is applied. The test unit is put inside an oven at a temperature between 80 to 180° C. (preferably 80 to 120° C.) for 2 to 24 hours (preferably 4 hours). After the end of test the test unit is disassembled. The glass sandwich is checked manually for easy separability. The removability is checked by blasting with pressurized air and by a washing process inside a lab washing machine. (20 min at 60° C., demineralized water)

Weathering Test

The test is conducted with glass sheets inside a special clamp system. A test glass unit consists of a minimum of 3 glass sheets. The glass sheets to be checked for glass corrosion are put in the middle of the sandwich. The glass samples are powdered manually or by aid of powdering unit with an amount of 100 to 1000 mg/m². The sandwich is put inside the clamp system and a high force ranging from 500 N to 2000 N (preferably 800 N) is applied. The test unit is put inside a weathering chamber. Different weathering tests can be conducted (preferably 60° C. at 92% relative humidity and a test duration of 14 days). After the end of the test the test unit is disassembled. The glass sandwich is checked manually for easy separability. The removability is checked by blasting with pressurized air and by a washing process inside a lab washing machine. (20 min at 60° C., demineralized water). After washing, the middle glass samples are checked for glass corrosion. The glass corrosion is evaluated by visual inspection under daylight condition or under edge illumination.

Application Inside Powdering Units

The behavior inside powdering units is conducted on commercially available roller or spraying units (e.g., Grafix or Grafotec). Glass samples are feed by aid of a conveyor belt. The homogeneity, dust behavior and glass adhesion are controlled.

Flowability

The flowability is checked by the flow behavior inside a test with a Ford Cup. The principal flowing behavior and also the flow time can be recorded.

It has been found, that products based on product type 1 and 2 gave excellent results after conducting all tests. Results are summarized in following table:

| | | |
|---|---|---|
| Test | Product type 1 | Product type 2 |

Temperature/pressure resistance

| | | |
|---|---|---|
| Separation | ++ (80° C. | ++ (80° C. |
| | to 120° C.) | to 120° C.) |
| Washability | ++ (80° C. | ++ (80° C. |
| | to 120° C.) | to 120° C.) |

Weathering test

| | | |
|---|---|---|
| Separation | ++ | ++ |
| Washability | + | ∘ |

Application inside powdering units

| | | |
|---|---|---|
| Homogeneity | ++ | ++ |
| Glass adhesion (PMMA = 90%) | 80% | 70 to 80% |
| Flowability | ++ | + |

Both product types show an excellent behavior inside temperature/pressure test.

Inside the weathering test the washability is not as good compared to PMMA bead polymer, but still sufficiently. The separation function is however working excellently.

Both products can be applied by commercially available powdering units used inside glass industry.

The glass adhesion is somewhat lower compared to a PMMA based polymer, but still sufficient. The flowability of both products types is in range.

Both products types can be mixed with acids (preferably adipic acid or succinic acid), which results in product providing a sufficient protection against glass corrosion. Mixing ratio is preferably ranging from 5 to 80% (preferably 10 to 50%).

1. A method for spacing glass sheets from one another during stacking of the glass sheets, characterized in that the method comprises applying an interleaving powder material between adjacent glass sheets whereby a composition comprising a powdered support material is employed, which is selected from the group consisting of a natural composite material based on cellulose, hemicellulose and/or lignin as the interleaving powder material between the adjacent glass sheets.

2. The method according to claim 1, characterized in that the natural composite material is selected from the group consisting of fruit kernel flour, cellulose-based powder, lignin-based powder and a mixture thereof.

3. The method according to claim 2, characterized in that the natural composite material is fruit kernel flour.

4. The method according to claim 3, characterized in that the fruit kernel flour is selected from the group consisting of olive pit flour, almond shell powder, peach stone powder, pistachio shell powder, avocado stone powder, grape powder, apricot stone powder, argan shell powder, corncob flour, walnut shell flour, manioc flour, guar gum, soya flour, chickpea flour, and mixtures thereof.

5. The method according to claim 2 characterized in that the natural composite material is cellulose-based powder.

6. The method according to claim 2 characterized in that the natural composite material is lignin-based powder.

7. The method according to claim 1, characterized in that the natural composite material further comprises at least one flow additive.

8. The method according to claim 7, characterized in that the at least one flow additive is selected from the group consisting of pyrogenic silica, pyrogenic aluminum oxide and a mixture thereof.

9. The method according to claim 1 characterized in that the composition further comprises an acid for protection of glass corrosion.

10. The method according to claim 9 characterized in that the acid is selected from the group consisting of adipic acid, succinic acid and boric acid.

11. The method according to claim 1, characterized in that the composition comprises
15 to 99.9 wt.-% powdered support material,
0 to 5 wt.-% flow additive, and
0 to 80 wt.-% of an acid selected from the group consisting of adipic acid, succinic acid and boric acid, based on the total weight of the composition.

12. The method according to claim 11, characterized in that the composition comprises
45 to 99.9 wt.-% powdered support material,
0.15 to 1 wt.-% flow additive, and
0 to 60 wt.-% or 5 to 60 wt.-% of an acid selected from the group consisting of adipic acid, succinic acid and boric acid, based on the total weight of the composition.

13. The method according to claim 11, characterized in that the powdered support material is a fruit kernel flour selected from the group consisting of olive pit flour, almond shell powder, peach stone powder, pistachio shell powder, avocado stone powder, grape kernel powder, apricot stone powder, argan shell powder, corncob flour, walnut shell flour, manioc flour, guar gum, soya flour, chickpea flour and mixtures thereof, or a cellulose-based material comprising at least 90 wt.-% cellulose, or a mixture of fruit kernel flour and the cellulose-based material comprising at least 90 wt.-% cellulose;
the at least one flow additive is selected from the group consisting of pyrogenic silica, pyrogenic aluminum oxide and a mixture thereof; and
the acid is selected from the group consisting of adipic acid and succinic acid and a mixture thereof.

14. The method according to claim 13, characterized in that the powdered support material is selected from the group consisting of olive pit flour, almond shell powder, grape kernel powder, corncob flour, walnut shell flour, mixtures thereof, a cellulose-based material comprising at least 95 wt.-% cellulose, and a mixture of one or more of olive pit flour, almond shell powder, grape kernel powder, corncob flour, walnut shell flour, and the cellulose-based material comprising at least 95 wt.-% cellulose;
the at least one flow additive is pyrogenic aluminum oxide; and
the acid is adipic acid.

15. The method according to claim 7, characterized in that the median particle size of the natural composite material and the at least one flow additive is 50 to 250 μm.

16. A combination of stacked glass sheets and interleaving powder material provided between the stacked glass sheets, comprising the interleaving powder material being located between adjacent stacked glass sheets characterized in that the interleaving powder material comprises a composition as defined in claim 1.

17. A method for producing the combination of stacked glass sheets and interleaving material according to claim 16 by spacing glass sheets from one another during stacking of the glass sheets, characterized in that the method comprises applying the interleaving powder between adjacent glass sheets.

18. A method of using the method for spacing glass sheets from one another during stacking of the glass sheets as defined in claim 1, the method comprising using the method for spacing glass sheets from one another during stacking of the glass sheets for the storage and transport of glass, for the storage and transport of non-coated flat glass, for the storage and transport of glass coated with an anti-corrosive coating, or for the storage and transport of coated glass (sputtered glass and lacquered glass).

19. The method according to claim 7, characterized in that the median particle size of the natural composite material and the at least one flow additive is 60 to 210 μm.

20. The method according to claim 7, characterized in that the median particle size of the natural composite material and the at least one flow additive is 80 to 150 μm.
